(19) United States
(12) Patent Application Publication
(10) Pub. No.: US 2006/0219134 A1
(43) Pub. Date: Oct. 5, 2006

(54) Monoazoquinolone pigments, process for their preparation and their use

(76) Inventors: Johannes Benkhoff, Basel (CH); Olof Wallquist, Therwil (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/549,525

(22) PCT Filed: Mar. 15, 2004
(86) PCT No.: PCT/EP04/50308

§ 371 Date: Sep. 19, 2005

(30) Foreign Application Priority Data
Mar. 25, 2003 (CH) 20030515/03

(51) Int. Cl. C09D 11/00; C09B 27/00

(52) U.S. Cl. 106/31.77; 106/31.79; 106/31.8; 106/496

(57) ABSTRACT

Monoazoquinolone pigments which, in one of their tautomeric forms, correspond to formula (1), wherein W is unsubstituted or substituted C₆-C₂₄aryl or unsubstituted or substituted heteroaryl or is a radical of formula (1a), wherein Ar₂ is unsubstituted or substituted C₆-C₂₄aryl or unsubstituted or substituted heteroaryl, Ar₁ is unsubstituted or substituted C₆-C₂₄aryl or unsubstituted or substituted heteroaryl, R, R₁, and R₂ are each independently of the others hydrogen, C₁-C₆alkyl, halogen, cyano, CF₃, nitro, NR₃R₄, COOR₄, NR₄COR₃, COO⁻X⁺, COR₄, OR₄, SR₃, SO₂R₃, SO₂NR₃R₄, SO₃^{-X}⁺, or C₆-C₂₄aryl which is unsubstituted or mono- or polysubstituted by R₅, R₃ is C₁-C₆alkyl, or C₆-C₁₂aryl which is unsubstituted or mono- or poly-substituted by halogen, hydroxy, OR₇, cyano, nitro, SR₇, NR₆R₇, COOR₇, CONR₆R₇, NR₆COR₇, NR₆COOR₇, COO⁻X₊, COR₄, OR₄, SO₂R₇, SO₂NR₆R₇, SO₃⁻X⁺ or by SO₃R₇, R₄ is hydrogen or has the meanings of R₃, R₅ is hydrogen, C₁-C₄alkyl, halogen, nitro, NR₇R₈ or OR₇, R₆ is hydrogen or C₁-C₃alkyl, R₇ and R₈ are each independently of the other hydrogen; C₁-C₃alkyl; phenyl which is unsubstituted or mono- or poly-substituted by halogen, nitro, OR₅, NR₁₆R₁₇; or benzyl which is unsubstituted or mono- or poly-substituted by halogen, nitro, OR₅, NR₁₆R₁₇, and X⁺ is a cation H⁺, Li⁺, Na⁺, K⁺, Mg⁺⁺_{1/2}, Ca⁺⁺_{1/2}, Sr⁺⁺_{1/2}, Ba^{++1/2}, Cu⁺, Cu⁺⁺_{1/2}, Zn⁺⁺_{1/2}, Mn⁺⁺_{1/2}, Al⁺⁺⁺_{1/3} or [NR₉R₁₀R₁₁R₁₂]⁺, wherein R₉, R₁₀, R₁₁ and R₁₂ are each independently of the others hydrogen; C₁-C₆alkyl; phenyl which is unsubstituted or mono- or poly-substituted by C₁-C₆alkyl, halogen, nitro, OR₅, NR₁₆R₁₇; or benzyl which is unsubstituted or mono- or poly-substituted by C₁-C₆alkyl, halogen, nitro,OR₅, NR₁₆R₁₇, and R₁₆ and R₁₇ are each independently of the other hydrogen or C₁-C₆alkyl, are suitable for the colouring of high molecular weight material and are distinguished by good fastness properties of the resulting colourations.

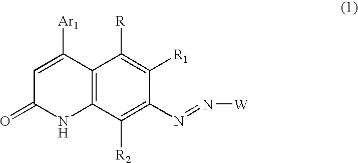

The present invention relates to novel monoazoquinolone pigments, to a process for their preparation and to their use as colourants, especially for colouring high molecular weight material.

Monoazoquinolone pigments are known. For example, U.S. Pat. 3,119,808 discloses monoazo-quinolone pigments containing neither sulfonic acid groups nor carboxylic acid groups in the coupling component.

The ever greater demands made of the quality of colourations, for example the fastness properties, or of application-related properties, for example the migration behaviour or the oversprayability, have resulted in there still being a need for new pigments that exhibit improved properties, especially with regard to fastness properties.

Accordingly, the object underlying the present invention is to find novel, improved monoazo-quinolone pigments, especially for producing surface coatings, printing inks and colour filters or for the colouring of plastics, which pigments possess the above-characterised qualities to a high degree. The novel pigments should yield colourations having a high purity of shade, high tinctorial strength and good fastness to overspraying and migration. The resulting colourations should especially exhibit good fastness to heat, light and weathering.

It has been found that the stated object is largely achieved by the novel monoazoquinolone pigments defined hereinbelow.

Accordingly, the present invention relates to monoazoquinolone pigments which, in one of their tautomeric forms, correspond to formula 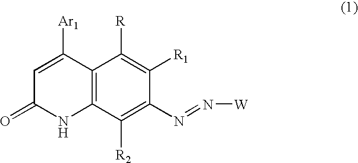
wherein

W is unsubstituted or substituted C₆-C₂₄aryl or unsubstituted or substituted heteroaryl or is a radical of formula 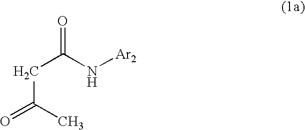
wherein
Ar₂ is unsubstituted or substituted C₆-C₂₄aryl or unsubstituted or substituted heteroaryl,
Ar₁ is unsubstituted or substituted C₆-C₂₄aryl or unsubstituted or substituted heteroaryl,
R, R₁ and R₂ are each independently of the others hydrogen, C₁-C₆alkyl, halogen, cyano,
CF₃, nitro, NR₃R₄, COOR₄, NR₄COR₃, COO⁻X⁺, COR₄, OR₄, SR₃, SO₂R₃SO₂NR₃R₄, SO₃⁻X⁺, or C₆-C₂₄aryl which is unsubstituted or mono- or poly-substituted by R₅,
R₃ is C₁-C₆alkyl, or C₆-C₁₂aryl which is unsubstituted or mono- or poly-substituted by halogen, hydroxy, OR₇, cyano, nitro, SR₇, NR₆R₇, COOR₇, CONR₆R₇, NR₆COR₇, NR₆COOR₇, COO⁻X⁺, COR₄, OR₄, SO₂R₇, SO₂NR₆R₇, SO₃⁻X⁺ or by SO₃R₇,
R₄ is hydrogen or has the meanings of R₃,
R₅ is hydrogen, C₁-C₄alkyl, halogen, nitro, NR₇R₈ or OR₇,
R₆ is hydrogen or C₁-C₃alkyl,
R₇ and R₈ are each independently of the other hydrogen; C₁-C₃alkyl; phenyl which is unsubstituted or mono- or poly-substituted by halogen, nitro, OR₅, NR₁₆R₁₇; or benzyl which is unsubstituted or mono- or poly-substituted by halogen, nitro, OR₅, NR₁₆R₁₇, and
X⁺ is a cation H⁺, Li⁺, Na⁺, K⁺, Mg⁺⁺_{1/2}, Ca⁺⁺_{1/2}, Sr⁺⁺_{1/2}, Ba⁺⁺_{1/2}, Cu⁺, Cu⁺⁺_{1/2}, Zn⁺⁺_{1/2}, Mn⁺⁺_{1/2},
Al⁺⁺⁺_{1/3} or [NR₉R₁₀R₁₁R₁₂]⁺, wherein R₉, R₁₀, R₁₁, and R₁₂ are each independently of the others hydrogen; C₁-C₆alkyl; phenyl which is unsubstituted or mono- or poly-substituted by C₁-C₆alkyl, halogen, nitro, OR₅, NR₁₆R₁₇; or benzyl which is unsubstituted or mono- or poly-substituted by C₁-C₆alkyl, halogen, nitro, OR₅, NR₁₆R₁₇, and
R₁₆ and R₁₇ are each independently of the other hydrogen or C₁-C₆alkyl.

Preferred monoazoquinolone pigments correspond to formula 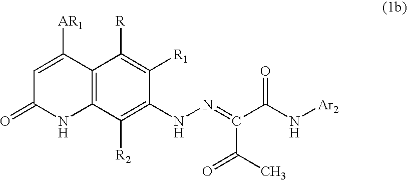
wherein
Ar₁ and Ar₂ are each independently of the other unsubstituted or substituted C₆-C₂₄aryl or unsubstituted or substituted heteroaryl,
R, R₁ and R₂ are each independently of the others hydrogen, C₁-C₆alkyl, halogen, cyano, CF₃, nitro, NR₃R₄, COOR₄, NR₄COR₃, COO⁻X⁺, COR₄, OR₄, SR₃, SO2R₃, SO₂NR₃R₄, SO₃⁻X⁺, or C₆-C₂₄aryl which is unsubstituted or mono- or poly-substituted by R₅,
R₃ is C₁-C₆alkyl, or C₆-C₁₂aryl which is unsubstituted or mono- or poly-substituted by halogen, hydroxy, OR₇, cyano, nitro, SR₇, NR₆R₇, COOR₇, CONR₆R₇, NR₆COR₇, NR₆COOR₇, COO⁻X⁺, COR₄, OR₄, SO₂R₇, SO₂NR₆R₇, SO₃⁻X⁺ or by SO₃R₇,
R₄ is hydrogen or has the meanings of R₃,
R₅ is hydrogen, C₁-C₄alkyl, halogen, nitro, NR₇RB or OR₇,
R₆ is hydrogen or C₁-C₃alkyl,
R₇ and R₈ are each independently of the other hydrogen; C₁-C₃alkyl; phenyl which is unsubstituted or mono- or poly-substituted by halogen, nitro, OR₅, NR₁₆R₁₇; or benzyl which is unsubstituted or mono- or poly-substituted by halogen, nitro, OR₅, NR₁₆R₁₇, and
X⁺ is a cation H⁺, Li⁺, Na⁺, K⁺, Mg⁺⁺_{1/2}, Ca⁺⁺_{1/2}, Sr⁺⁺_{1/2}, Ba⁺⁺_{1/2}, Cu⁺, Zn⁺⁺_{1/2}, Mn⁺⁺_{1/2}, Al⁺⁺⁺_{1/3} or [NR₉R₁₀R₁₁R₁₂]⁺, wherein R₉, R₁₀, R₁₁, and R₁₂ are each independently of the others hydrogen; C₁-C₆alkyl; phenyl which is unsubstituted or mono- or poly-substituted by C₁-C₆alkyl, halogen, nitro, OR₅, NR₁₆R₁₇; or benzyl which is unsubstituted or mono- or poly-substituted by C₁-C₆alkyl, halogen, nitro, OR₅, NR₁₆R₁₇, and
R₁₆ and R₁₇ are each independently of the other hydrogen or C₁-C₆alkyl.

There come into consideration as C₆-C₂₄aryl for W, Ar₁ and Ar₂ each independently of the others, for example, phenyl, 1-naphthyl, 2-naphthyl, 4-biphenyl, phenanthryl, 2- or 9-fluorenyl or anthracenyl, preferably phenyl, 1-naphthyl or 2-naphthyl.

W, Ar₁ and Ar₂ as heteroaryl are each independently of the others, for example, a polyunsaturated heterocyclic ring system comprising from 5 to 18 atoms selected from C, N, O and S and containing at least 6 conjugated π-electrons. Such a structure is, for example, thienyl, benzo[b]thienyl, dibenzo[b,d]thienyl, thianthrenyl, furyl, furfuryl, 2H-pyranyl, benzofuranyl, isobenzofuranyl, dibenzofuranyl, phenoxythiinyl, pyrrolyl, imidazolyl, pyrazolyl, pyridyl, bipyridyl, triazinyl, pyrimidinyl, pyrazinyl, pyridazinyl, indolizinyl, isoindolyl, indolyl, indazolyl, purinyl, quinolizinyl, quinolyl, isoquinolyl, phthalazinyl, naphthyridinyl, quinoxalinyl, quinazolinyl, cinnolinyl, pteridinyl, carbazolyl, carbolinyl, benzotriazolyl, benzoxazolyl, phenanthridinyl, acridinyl, perimidinyl, phenanthrolinyl, phenazinyl, isothiazolyl, phenothiazinyl, furazanyl or phenoxazinyl.

C₁-C₆Alkyl as R, R₁, R₂, R₃, R₄, R₉, R₁₀, R₁₁, R₁₂, R₁₆ and R₁₇ and as a substituent in R₉, R₁₀, R₁₁, and R₁₂, each independently of the others, is, for example, methyl, ethyl, n-propyl, isopropyl, n-butyl, sec-butyl, tert-butyl, isobutyl, heptyl or hexyl.

R, R₁ and R₂ as C₆-C₂₄aryl are each independently of the others, for example, phenyl and naphthyl.

R₃ and R₄ as C₆-Cl₂aryl are each independently of the other, for example, phenyl and naphthyl.

R₅ as C₁-C₄alkyl is methyl, ethyl, n-propyl, isopropyl, n-butyl, sec-butyl, tert-butyl or isobutyl, preferably methyl or ethyl and especially methyl.

C₁-C₃Alkyl as R₆, R₇ and R₈, each independently of the others, is methyl, ethyl, n-propyl and isopropyl.

There come into consideration as halogen for R, R₁, R₂ and R₅ and as a substituent in R₃, R₇, R₈, R₉, R₁₀, R₁₁, and R₁₂, each independently of the others, for example, fluorine, chlorine or bromine, preferably chlorine or bromine and especially chlorine.

Ar₁ as an aryl radical is preferably a phenyl or naphthyl radical, it being possible for those radicals to be unsubstituted or substituted by one or more substituents R₈.

Ar₁ is preferably a radical of formula 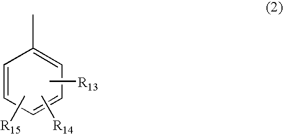
wherein

R₁₃, R₁₄ and R₁₅ are each independently of the others hydrogen, C₁-C₆alkyl, halogen, cyano, CF₃, nitro, NR₃R₄, COOR₄, NR₄COR₃, COO⁻X⁺, COR₄, OR₄, SR₃, SO₂R₃SO₂NR₃R₄, SO₃⁻X⁺, or C₆-C₁₂aryl which is unsubstituted or mono- or poly-substituted by R₅.

Ar₂ is preferably a radical of formula 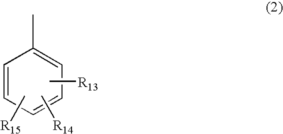
wherein

R₁₃, R₁₄ and R₁₅ are each independently of the others hydrogen, C₁-C₆alkyl, halogen, cyano, CF₃, nitro, NR₃R₄, COOR₄, NR₄COR₃, COO⁻X⁺, COR₄, OR₄, SR₃, SO₂R₃, SO₂NR₃R₄, SO₃R₄, SO₃⁻X⁺, or C₆-C₁₂aryl which is unsubstituted or mono- or poly-substituted by R₅.

In a preferred embodiment of the monoazoquinolone pigments of formula (1) according to the invention, R₁ and R₂ are each independently of the other hydrogen, C₁-C₃alkyl, C₁-C₃alkoxy, chlorine, COOR₅, NR₄COR₃, COO⁻X⁺ or SO₃⁻X⁺, R₅ is hydrogen or C₁-C₃alkyl and X⁺ is a cation Na⁺, Mg⁺⁺_{1/2}, Ca⁺⁺_{1/2}, Sr⁺⁺_{1/2}, Ba⁺⁺_{1/2} or [NR₉R₁₀R₁₁R₁₂ ]⁺, wherein R₉R₁₀, R₁₁ and R₁₂ are each independently of the others hydrogen; C₁-C₆alkyl; phenyl which is unsubstituted or mono- or poly-substituted by C₁-C₃alkyl, halogen, nitro, OR₇, N(R₇)₂; or benzyl which is unsubstituted or mono- or poly-substituted by C₁-C₃alkyl, halogen, nitro, OR₇, N(R₇)₂.

In a further preferred embodiment of the monoazoquinolone pigments of formula (1) according to the invention, R₁ and R₂ are each independently of the other hydrogen, C₁-C₂alkyl, C₁-C₂alkoxy, chlorine, COOR₅, NR₄COR₃, COO⁻X⁺ or SO₃⁻X⁺, R₅ is hydrogen or C₁-C₂alkyl and X⁺ is a cation Na⁺, Mg⁺⁺_{1/2}, Ca⁺⁺_{1/2}, Sr⁺⁺_{1/2}, Ba⁺⁺_{1/2} or [NR₉R₁₀R₁₁R₁₂]⁺, wherein R₉, R₁₀, R₁₁, and R₁₂ are each independently of the others hydrogen, C₁-C₆alkyl, phenyl which is unsubstituted or mono- or poly-substituted by C₁-C₂alkyl and/or by halogen, or benzyl which is unsubstituted or mono- or poly-substituted by C₁-C₂alkyl and/or by halogen.

In another embodiment of the monoazoquinolone pigments of formula (1) according to the invention which is likewise preferred, R₁, and R₂ are each independently of the other hydrogen, C₁-C₂alkyl, C₁-C₂alkoxy, chlorine, COOR₅ or NR₄COR₃ and R₅ is hydrogen or C₁-C₂alkyl.

Very special preference is given to monoazoquinolone pigments of formulae 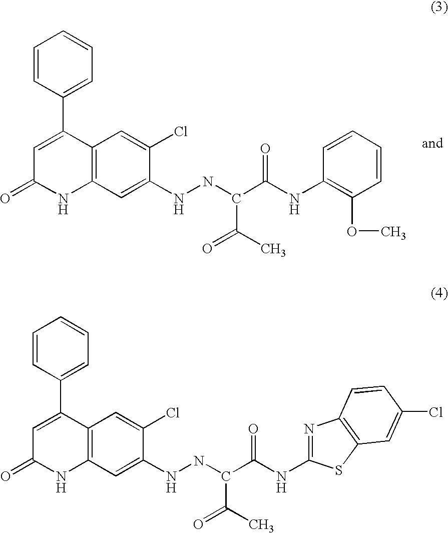
and also to the pigments listed in Tables 1 to 4 hereinbelow.

The present invention relates also to a process for the preparation of monoazoquinolone pigments of formula (1), wherein a compound of formula 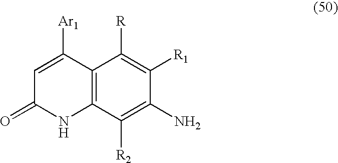
is diazotised and coupled to a compound of formula
W—H (51)
or to a compound of formula 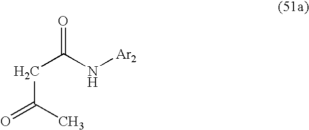
wherein W, Ar₁, Ar₂, R, R₁ and R₂ have the definitions and preferred meanings mentioned above.

The diazotisation of the compound of formula (50) is carried out, for example, using a nitrite, for example an alkali metal nitrite, such as sodium nitrite, in a mineral-acid medium, for example in a hydrochloric acid medium, at temperatures of, for example, from −5 to 40° C. and preferably at from −5 to 10° C.

The coupling to the coupling component, the compound of formula (51) or (51a), is carried out in a manner known per se at acid, neutral to weakly alkaline pH values, for example at a pH value of from 1 to 10, and at temperatures of, for example, from −5 to 40° C., preferably from 0 to 30° C.

The process according to the invention is advantageously carried out by slowly adding a freshly prepared solution or suspension of the diazotised compound of formula (50) to a weakly acid to neutral solution or suspension of the acetoacetanilide coupling component of formula (51a), the pH being maintained in the neutral range, for example at pH 4.5 to 8, by addition of an aqueous alkali hydroxide solution, for example a sodium hydroxide solution, subsequently stirring the resulting pigment suspension until the reaction is complete, and isolating the product by filtration.

The compounds of formula (50) are novel and the present invention relates also thereto. Such compounds can be obtained, for example, according to the process described in JP-A-2001-287466 or in Journal of Chemical and Engineering Data, Vol. 13, No. 3, July 1968, for example by reacting a compound of the formula 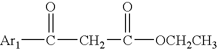
with a compound of the formula 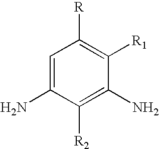
in xylene at a temperature of from 130 to 140° C., Ar₁, R, R₁ and R₂ being as defined for formula (1b).

The compounds of formulae (51) and (51a) are known and can be obtained by processes known per se.

The coupling components of formula (51) are generally aromatic or heteroaromatic compounds having nucleophilic centres on the aromatic nucleus, especially naphthols or enolisable compounds having reactive methylene groups, as are described, for example, in Colour Index, 3rd Edition, Volume 4 or in The Society of Dyers and Colorists, 1971, pages 4355-4364 and 37500-37625.

Preferred coupling components are:
methylene-active compounds of the formula 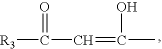
   wherein R₃ is methyl, aryl or CF₃,
2-hydroxynaphthalene and its 3-carboxylic acid derivatives, for example 2′-hydroxy-3′-naphthylanilines of the formula 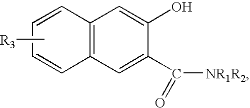
   wherein R₁, R₂ and R₃ are as defined above,
pyrazolone derivatives, especially those of the formula 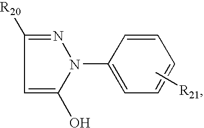
   wherein R₂₀ is C₁-C₄alkyl, especially methyl, or COOR₁, R₁ being as defined for formula (1) above, and R₂₁ is hydrogen, halogen, sulfo or C₁-C₄alkyl, especially methyl,
cyanoacetic acid derivatives of the formula 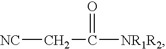
   wherein R₁ and R₂ are as defined above, and
pyridones of the formula

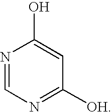

The monoazoquinolone pigments of formula (1) according to the invention are suitable as colourants for colouring high molecular weight material.

The high molecular weight material can be organic or inorganic and may be a synthetic and/or natural material. It may be, for example, a natural resin or drying oil, rubber or casein, or a modified natural material such as chlorinated rubber, an oil-modified alkyd resin, viscose, a cellulose ether or ester, such as ethyl cellulose, cellulose acetate, propionate or butyrate, cellulose acetobutyrate as well as nitrocellulose, but especially a totally synthetic organic polymer (thermoseffing plastic or thermoplastic), as can be obtained by polymerisation, for example by polycondensation or polyaddition. The polymer class includes, for example, polyolefins, such as polyethylene, polypropylene, polyisobutylene, also substituted polyolefins, such as polymerisation products of monomers such as vinyl chloride, vinyl acetate, styrene, acrylonitrile, acrylic acid esters, methacrylic acid esters; fluoropolymers, for example polyfluoroethylene, polytrifluorochloroethylene or tetrafluoroethylene/hexafluoropropylene mixed polymers, as well as copolymers of the mentioned monomers, especially ABS (acrylonitrile/butadiene/styrene) or EVA (ethylene/vinyl acetate). From the group of the polyaddition and polycondensation resins it is possible to use, for example, condensation products of formaldehyde with phenols, the so-called phenoplasts, and condensation products of formaldehyde and urea or thiourea, and also melamine, the so-called aminoplasts, also the polyesters used as surface-coating resins, either saturated, such as alkyd resins, or unsaturated, such as maleic resins, also linear polyesters, polyamides, polyurethanes, polycarbonates, polyphenylene oxides or silicones, and silicone resins.

The mentioned high molecular weight compounds may be present individually or in mixtures, in the form of plastic compositions or melts, which may optionally be spun to form fibres.

They may also be present in the form of their monomers or in the polymerised state in dissolved form as film-forming agents or binders for surface coatings, paints or printing inks, such as boiled linseed oil, nitrocellulose, alkyd resins, melamine resins, urea-formaldehyde resins or acrylic resins.

Pigmenting of the high molecular weight organic materials with the monoazoquinolone pigments according to the invention is carried out, for example, by adding such a pigment, optionally in the form of a masterbatch, to the substrates using rolling mills, mixing or grinding apparatuses. The pigmented material is then generally brought into the desired final form by methods known per se, such as calendering, compression moulding, extrusion, spread-coating, casting or by injection moulding. It is often desirable, in order to produce non-rigid mouldings or to reduce their brittleness, to incorporate so-called plasticisers into the high molecular weight compounds before they are shaped. There may be used as plasticisers, for example, esters of phosphoric acid, phthalic acid or sebacic acid. The plasticisers may be incorporated in the process according to the invention before or after the incorporation of the pigment colourant into the polymers. It is also possible, in order to achieve different shades of colour, to add to the high molecular weight organic materials, in addition to the monoazoquinolone pigments of formula (1), also fillers or other constituents imparting colour, such as white, coloured or black pigments as well as special-effect pigments, in each case in the desired amount.

For the pigmenting of surface coatings and printing inks, the high molecular weight organic materials and the monoazoquinolone pigments of formula (1), optionally together with additives such as fillers, other pigments, for example TiO₂, siccatives or plasticisers, are generally finely dispersed or dissolved in an organic and/or aqueous solvent or solvent mixture. The procedure may be such that the individual components are dispersed or dissolved separately or several are dispersed or dissolved together, and only then are all the components combined.

Based on the high molecular weight material to be pigmented, the monoazoquinolone pigments according to the invention can be used in an amount of from 0.01 to 30% by weight, preferably from 0.1 to 10% by weight.

Accordingly, the present invention relates also to the use of the monoazoquinolone pigments of formula (1) according to the invention in the colouring of high molecular weight material, especially organic high molecular weight material, which includes the use as a colourant for plastics in any form, for example in the form of fibres, surface coatings or printing inks.

The monoazoquinolone pigments of formula (1) according to the invention are especially suitable for the colouring, in the mass, of polyvinyl chloride and, especially, polyolefins, such as polyethylene and polypropylene, as well as of aqueous and/or solvent-based lacquers, for example automotive lacquers, also powder coatings, printing inks and paints.

The resulting colourations, for example in plastics, fibres, surface coatings or prints, are distinguished by a high purity of shade, high tinctorial strength, good fastness to overspraying and migration, and especially by good fastness to heat, light and weathering, for example in full-shade or reduction-with-white applications.

The monoazoquinolone pigments of formula (1) according to the invention are further distinguished by good dispersibility, good rheological behaviour and a high gloss of the colourations obtained therewith.

The monoazoquinolone pigments of formula (1) according to the invention are also suitable as colourants for the production of colour filters, especially for visible light in the range from 400 to 700 nm, for liquid crystal displays (LCD) or charge combined devices (CCD).

The production of colour filters by the sequential application of a red, blue and green pigment to a suitable substrate, for example amorphous silicon, is described in GB-A-2 182 165. The colour filters can be coated, for example, using inks, especially printing inks, comprising the monoazoquinolone pigments according to the invention, or, for example, by mixing the monoazoquinolone pigments according to the invention with chemically, thermally or photolytically structurable high molecular weight material. The further production can be carried out, for example, analogously to EP-A 654 711 by application to a substrate, such as an LCD, subsequent photostructuring and development. A further document which describes the production of colour filters is U.S. Pat. No. 5,624,467.

The colour filters produced with the pigments according to the invention for liquid crystal displays (LCD) exhibit an improved transmission window between 500 and 600 nm in comparison with previous colour filters, and they are therefore distinguished by high transmission of the green colour points. The colour filters produced with the pigments according to the invention have increased absorption at 400 nm in comparison with previous colour filters, which advantageously yields a more yellowish green.

The Examples which follow serve to illustrate the invention. In the Examples, unless indicated otherwise, parts are parts by weight and percentages are percentages by weight. Temperatures are given in degrees Celsius. The relationship between parts by weight and parts by volume is the same as that between grams and cubic centimetres.

### EXAMPLE 1

20 ml of 37% aqueous hydrochloric acid are added dropwise at 5° C., with stirring, to a suspension of 100 ml of glacial acetic acid, 20 ml of water and 8.12 g of 7-amino-6-chloro-4-phenylquinol-2-one (30 mmol). 7.5 ml (30 mmol) of an aqueous 4N sodium nitrite solution are then added dropwise at that temperature to the greenish-white suspension and stirring Is carried out for 90 minutes, the suspension slowly changing to a greenish-yellow solution. The cold solution is clarified by filtration over a glass fibre filter and the filtrate is transferred to a coolable dropping funnel adjusted to a temperature of 5° C.

In parallel, 8.87 g (33 mmol) of 2-acetoacetylamino-6-chlorobenzothiazole are suspended in 250 ml of ethyl alcohol and 125 ml of water and dissolved with the addition of 4.5 ml (45 mmol) of 30% aqueous NaOH. The colourless solution is clarified by filtration and the coupling component so prepared is then precipitated, with vigorous stirring, by addition of 45 ml of 25% aqueous acetic acid, the white suspension being adjusted to a pH value of 5.1.

The solution of the diazonium salt, adjusted to a temperature of 5° C., is then added dropwise in the course of 3 hours, with vigorous stirring, to the freshly precipitated coupling component suspension adjusted to a temperature of 0-5° C. and buffered to pH 5, the pH value being maintained by the simultaneous continuous addition of 130.5 ml of a 30% aqueous NaOH solution. The greenish-yellow pigment suspension is first left to stand for 12 hours at room temperature and is then heated for 3 hours under reflux. The resulting yellow pigment is filtered off while hot and washed with copious amounts of water until neutral and free of salt.

The pigment is then dried for 20 hours at 110° C. under a laboratory vacuum. There are obtained 16.1 g (29.2 mmol, yield 97%) of the pigment of formula 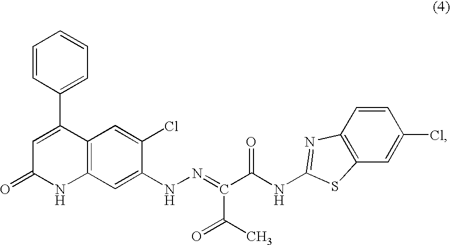
which in high molecular weight organic material yields greenish-yellow colourations having very good fastness to weathering.

### EXAMPLE 2

70 ml (0.8 mol) of 37% aqueous hydrochloric acid are added dropwise at 5° C., with stirring, to a suspension of 100 ml of glacial acetic acid, 100 ml of water and 21.65 g of 7-amino-6-chloro-4-phenylquinol-2-one (80 mmol). 20 ml (80 mmol) of an aqueous 4N sodium nitrite solution are then added dropwise at that temperature to the greenish-white suspension and stirring is carried out for 90 minutes, the suspension slowly changing to a greenish-yellow solution. The cold solution is clarified by filtration over a glass fibre filter and the filtrate is transferred to a coolable dropping funnel adjusted to a temperature of 5° C.

In parallel, 18.24 g (88 mmol) of acetoacet-2-anisidide are suspended in 250 ml of water and dissolved with the addition of 10 ml (100 mmol) of 30% aqueous NaOH. The colourless solution is clarified by filtration and the anisidide is then precipitated, with vigorous stirring, by addition of 50 ml of 30% aqueous acetic acid, the white suspension being adjusted to a pH value of 4.7.

The solution of the diazonium salt, adjusted to a temperature of 5° C., is then added dropwise in the course of 2.5 hours, with vigorous stirring, to the freshly precipitated anisidide suspension adjusted to a temperature of 0-5° C. and buffered to pH 4.5, the pH value being maintained by the simultaneous continuous addition of 197.5 ml of a 30% aqueous NaOH solution.

The greenish-yellow pigment suspension is first left to stand for 12 hours at room temperature and is then heated for 4 hours under reflux. The resulting yellow pigment is filtered off while hot and washed with copious amounts of water until neutral and free of salt.

The pigment is then dried for 20 hours at 110° C. under a laboratory vacuum.

There are obtained 32.8 g (67.1 mmol, yield 84%) of the pigment of formula 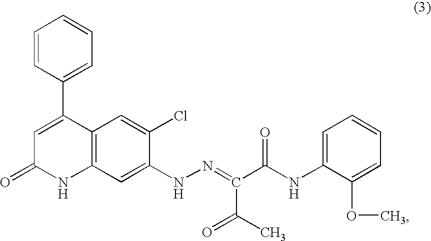
which in high molecular weight organic material yields greenish-yellow colourations having very good fastness to weathering.

### EXAMPLE 3

A suspension of 0.89 g (4 mmol) of 2-methoxy-5-methylacetoacetanilide and 1.08 g of 7-amino-6chloro-4-phenylquinol-2-one (4 mmol) in 30 ml of acetic acid and 34 ml of diglyme is heated for 60 minutes at 80° C. and then cooled to 40° C. 2.76 ml (4 mmol) of a 15% solution of tert-butylnitrile in acetic acid is added dropwise to the resulting clear reddish solution in the course of 80 minutes, the pigment precipitating in the form of a yellowish-orange solid. The reaction mixture is then heated for 6 hours at 80° C. and subsequently maintained at 50° C. for 16 hours.

The crude yellow pigment is filtered while still warm and then washed with copious amounts of water. The pigment is then dried for 20 hours at 110° C. in vacuo. There are obtained 1.75 g (3.5 mmol, yield 88%) of the pigment of formula 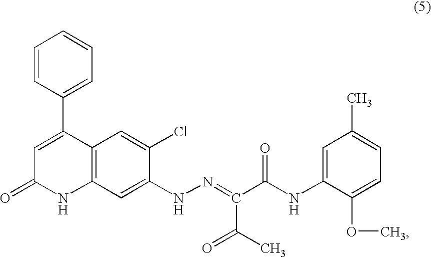
which in high molecular weight organic material yields yellow colourations having very good fastness to weathering.

### Examples 4 to 129

Analogously to the procedure described in Examples 1 to 3 it is possible to obtain pigments using the coupling components indicated in Table 1: In high molecular weight organic material the pigments yield colourations having the shade of colour indicated in each case and having very good fastness to weathering.

TABLE 1

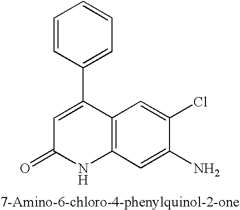

| Example | Coupling component | Shade |
|---|---|---|
| 4 | 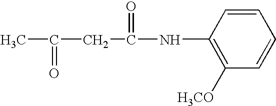 | highly greenish-yellow |
| 5 | 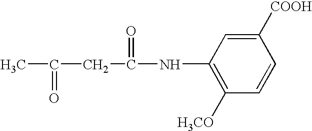 | greenish-yellow |
| 6 | 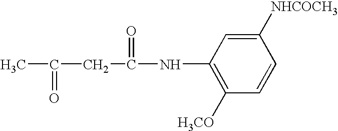 | yellow |
| 7 | 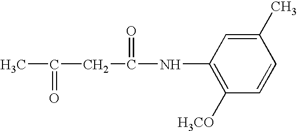 | greenish-yellow |
| 8 | 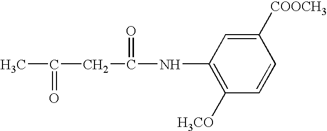 | highly greenish-yellow |
| 9 | 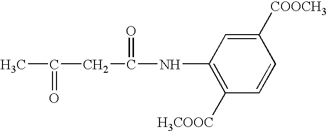 | highly greenish-yellow |
| 10 | 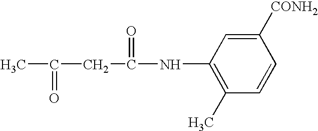 | highly greenish-yellow |
| 11 | 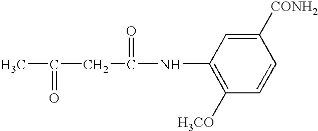 | highly greenish-yellow |
| 12 | 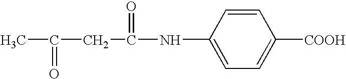 | greenish-yellow |
| 13 | 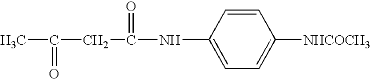 | greenish-yellow |
| 14 | 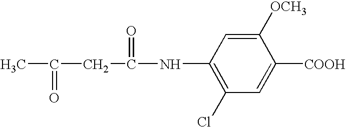 | highly greenish-yellow |
| 15 | 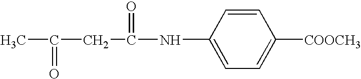 | greenish-yellow |
| 16 | 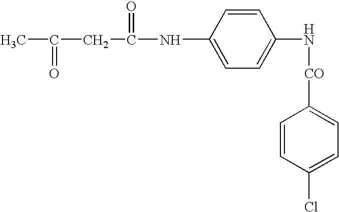 | yellow |
| 17 | 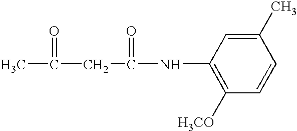 | yellow |
| 18 | 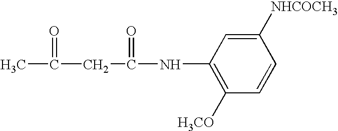 | yellow |
| 19 | 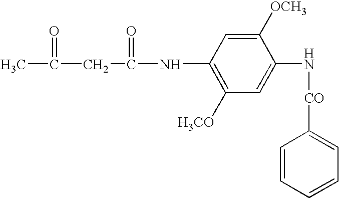 | reddish-yellow |
| 20 | 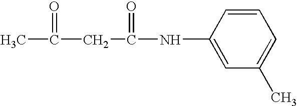 | reddish-yellow |
| 21 | 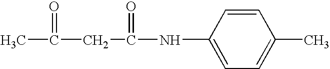 | yellow |
| 22 | 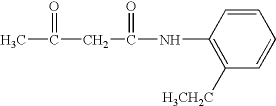 | reddish-yellow |
| 23 | 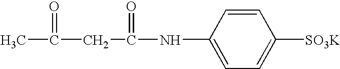 | reddish-yellow |
| 24 | 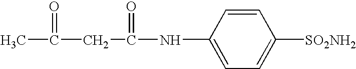 | greenish-yellow |
| 25 | 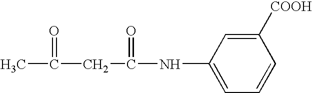 | yellow |
| 26 | 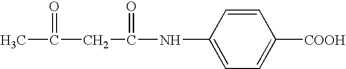 | yellow |
| 27 | 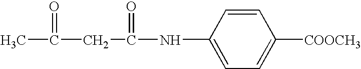 | reddish-yellow |
| 28 | 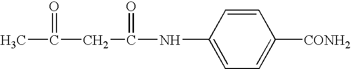 | reddish-yellow |
| 29 | 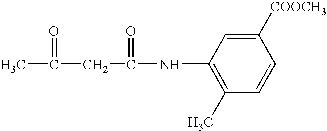 | reddish-yellow |
| 30 | 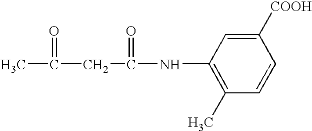 | reddish-yellow |
| 31 | 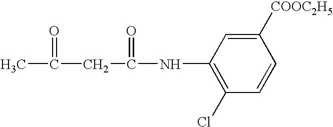 | greenish-yellow |
| 32 | 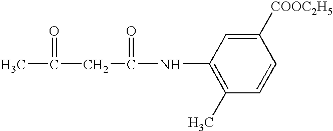 | reddish-yellow |
| 33 | 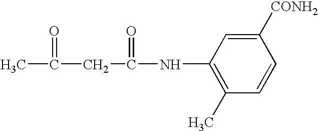 | greenish-yellow |
| 34 | 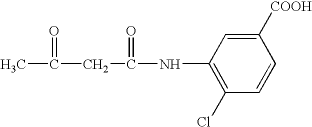 | greenish-yellow |
| 35 | 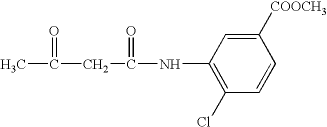 | greenish-yellow |
| 36 | 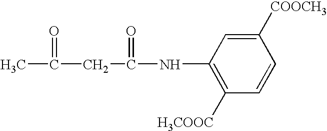 | yellow |
| 37 | 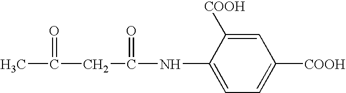 | greenish-yellow |
| 38 | 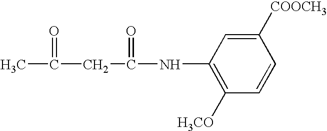 | yellow |
| 39 | 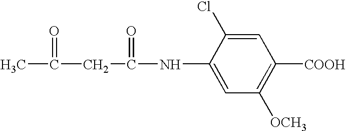 | yellow |
| 40 | 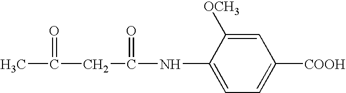 | yellow |
| 41 | 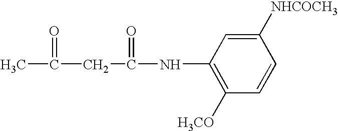 | reddish-yellow |
| 42 | 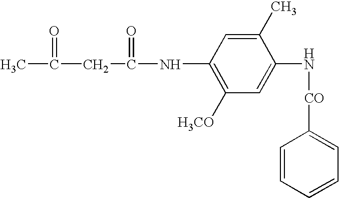 | reddish-yellow |
| 43 | 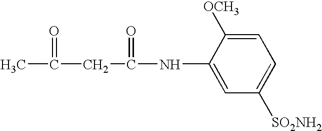 | reddish-yellow |
| 44 | 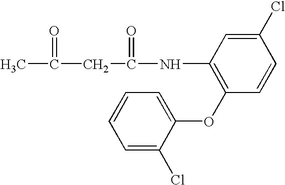 | yellow |
| 45 | 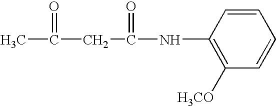 | reddish-yellow |
| 46 | 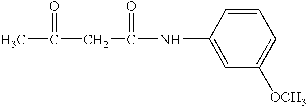 | reddish-yellow |
| 47 | 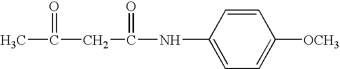 | reddish-yellow |
| 48 | 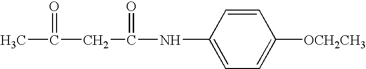 | reddish-yellow |
| 49 | 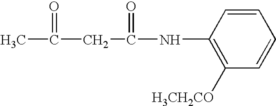 | yellow |
| 50 | 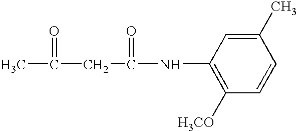 | reddish-yellow |
| 51 | 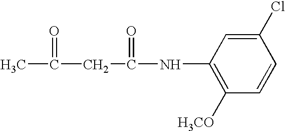 | yellow |
| 52 | 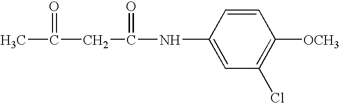 | reddish-yellow |
| 53 | 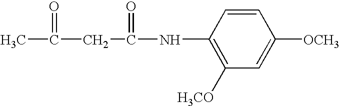 | reddish-yellow |
| 54 | 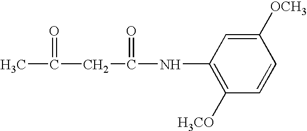 | reddish-yellow |
| 55 | 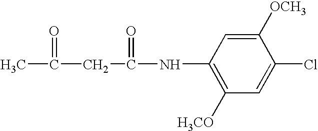 | reddish-yellow |
| 56 | 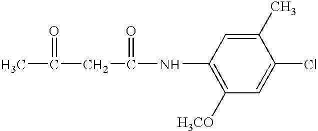 | yellow |
| 57 | 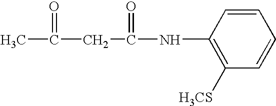 | yellow |
| 58 | 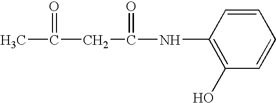 | reddish-yellow |
| 59 | 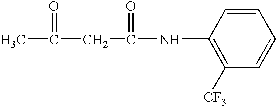 | yellow |
| 60 | 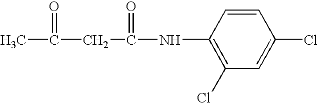 | yellow |
| 61 | 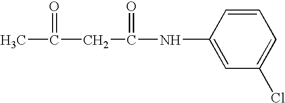 | yellow |
| 62 | 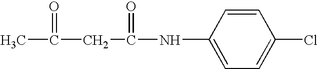 | reddish-yellow |
| 63 | 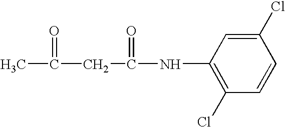 | yellow |
| 64 | 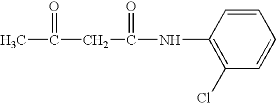 | reddish-yellow |
| 65 | 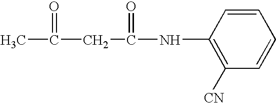 | reddish-yellow |
| 66 | 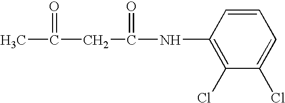 | yellow |
| 67 | 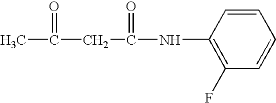 | yellow |
| 68 | 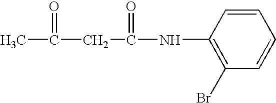 | reddish-yellow |
| 69 | 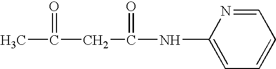 | yellow |
| 70 | 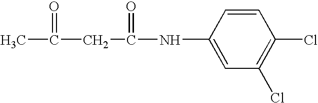 | reddish-yellow |
| 71 | 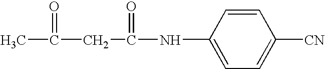 | reddish-yellow |
| 72 | 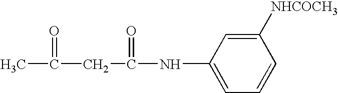 | reddish-yellow |
| 73 | 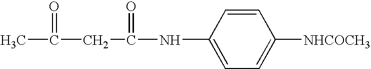 | reddish-yellow |
| 74 | 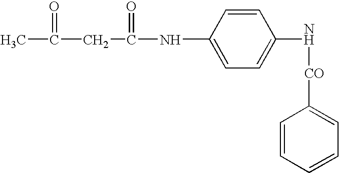 | reddish-yellow |
| 75 | 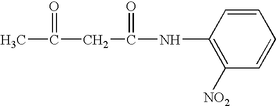 | reddish-yellow |
| 76 | 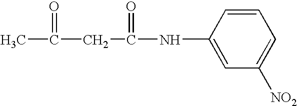 | yellow |
| 77 | 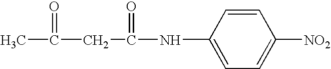 | yellow |
| 78 | 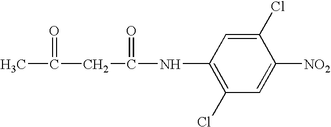 | reddish-yellow |
| 79 | 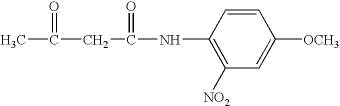 | reddish-yellow |
| 80 | 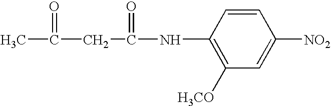 | yellow |
| 81 | 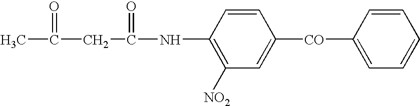 | yellow |
| 82 | 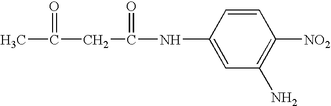 | reddish-yellow |
| 83 | 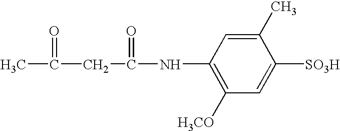 | yellow |
| 84 | 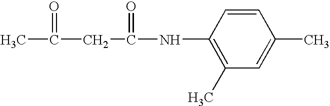 | yellow |
| 85 | 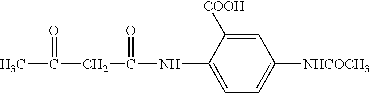 | yellow |
| 86 | 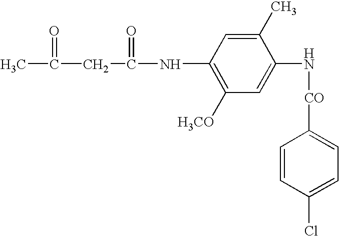 | yellow |
| 87 | 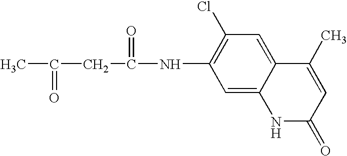 | greenish-yellow |
| 88 | 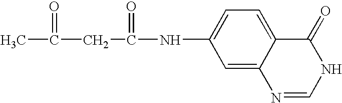 | yellow |
| 89 | 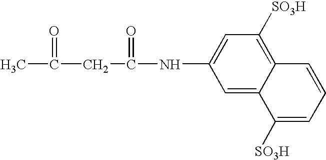 | yellow |
| 90 | 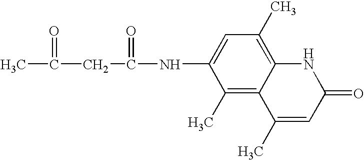 | yellow |
| 91 | 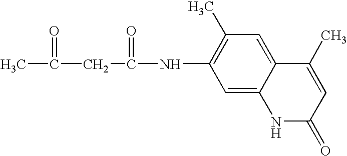 | yellow |
| 92 | 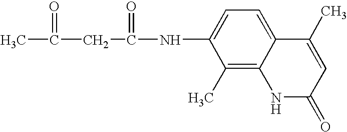 | reddish-yellow |
| 93 | 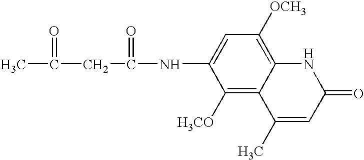 | reddish-yellow |
| 94 | 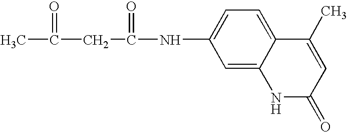 | yellow |
| 95 | 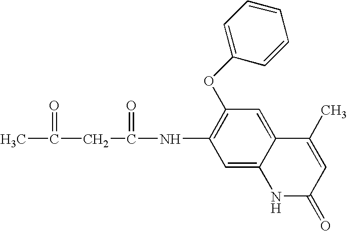 | yellow |
| 96 | 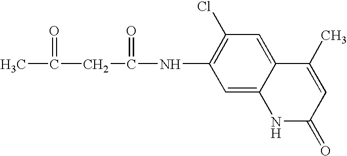 | yellow |
| 97 | 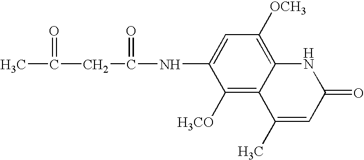 | reddish-yellow |
| 98 | 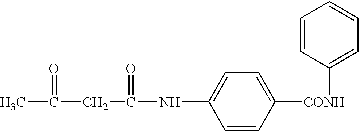 | reddish-yellow |
| 99 | 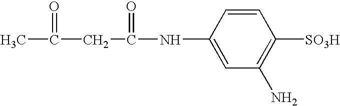 | reddish-yellow |
| 100 | 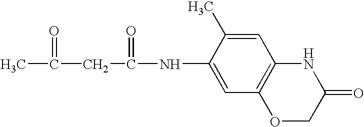 | yellow |
| 101 | 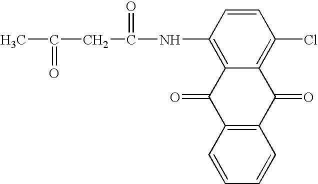 | greenish-yellow |
| 102 | 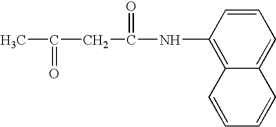 | yellow |
| 103 | 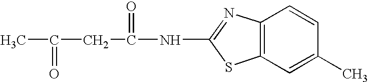 | greenish-yellow |
| 104 | 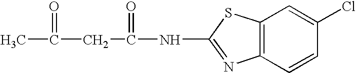 | greenish-yellow |
| 105 | 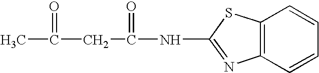 | greenish-yellow |
| 106 | 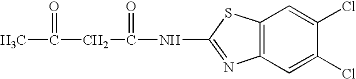 | yellow |
| 107 | 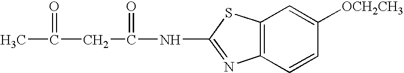 | reddish-yellow |
| 108 | 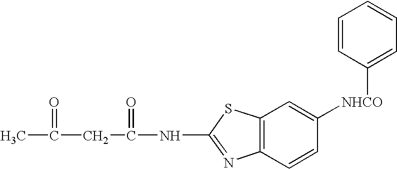 | reddish-yellow |
| 109 | 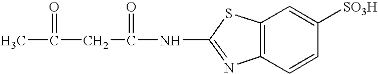 | reddish-yellow |
| 110 | 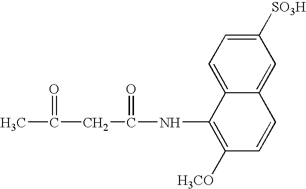 | greenish-yellow |
| 111 | 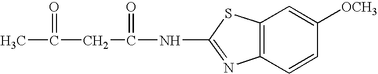 | yellow |
| 112 | 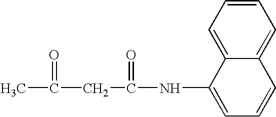 | reddish-yellow |
| 113 | 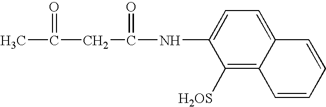 | reddish-yellow |
| 114 | 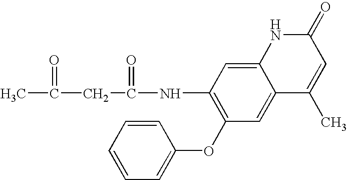 | yellow |
| 115 | 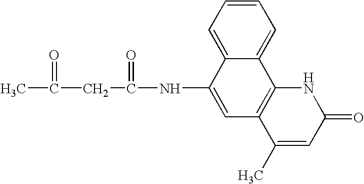 | reddish-yellow |
| 116 | 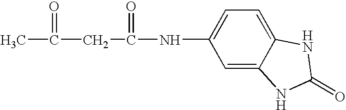 | reddish-yellow |
| 117 | 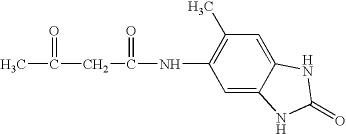 | reddish-yellow |
| 118 | 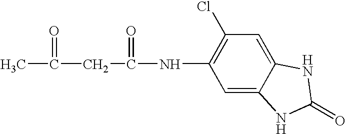 | reddish-yellow |
| 119 | 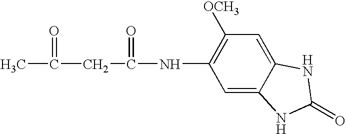 | reddish-yellow |
| 120 | 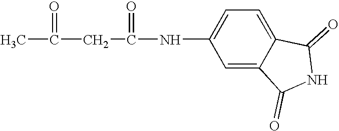 | yellow |
| 121 | 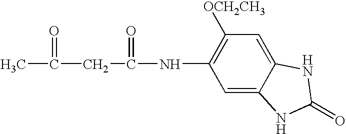 | reddish-yellow |
| 122 | 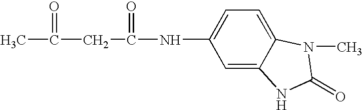 | reddish-yellow |
| 123 | 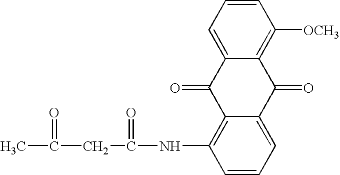 | yellow |
| 124 | 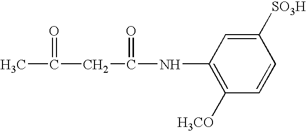 | greenish-yellow |
| 125 | 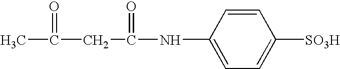 | greenish-yellow |
| 126 | 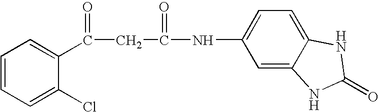 | reddish-yellow |
| 127 | 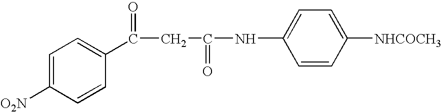 | reddish-yellow |
| 128 | 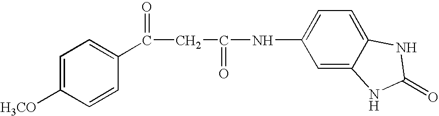 | reddish-yellow |
| 129 | 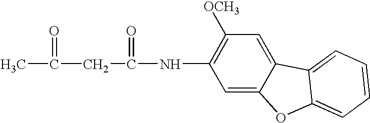 | reddish-yellow |

### Examples 130 and 131

Analogously to the procedure described in Examples 1 to 3 it is possible to obtain pigments using the coupling components indicated in Table 2: In high molecular weight organic material the pigments yield colourations having the shade of coluor indicated in each case and having very good fastness to weathering.

TABLE 2

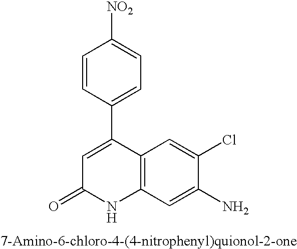

| Example | Coupling component | Shade |
|---|---|---|
| 130 | 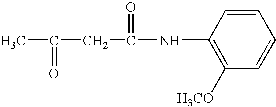 | highly greenish-yellow |
| 131 | 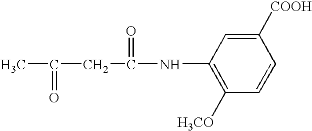 | highly greenish-yellow |

### Examples 132 to 141

Analogously to the procedure described in Examples 1 to 3 it is possible to obtain pigments using the coupling components indicated in Table 3: In high moleculer weight organic material the pigments yield colourations having the shade of colour indicated in each case and having very good fastness to weathering.

TABLE 3

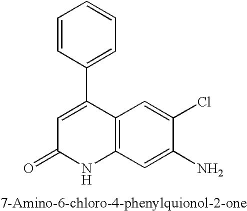

| Example | Coupling component | Shade |
|---|---|---|
| 132 | 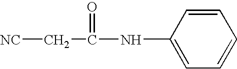 | yellow |
| 133 | 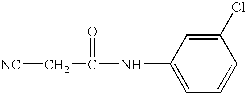 | reddish-yellow |
| 134 | 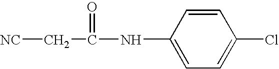 | reddish-yellow |
| 135 | 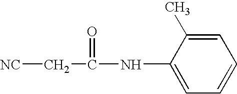 | yellow |
| 136 | 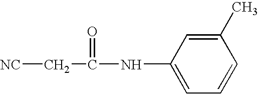 | reddish-yellow |
| 137 | 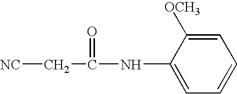 | reddish-yellow |
| 138 | 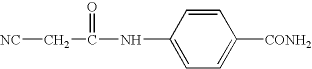 | reddish-yellow |
| 139 | 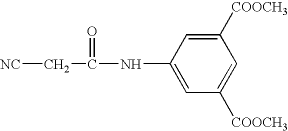 | yellow |
| 140 | 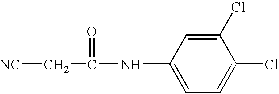 | yellow |
| 141 | 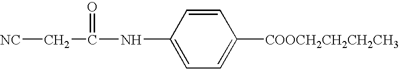 | yellow |

### Examples 142 to 165

Analogously to the procedure described in Examples 1 to 3 it is possible to obtain pigments using the coupling components indicated in Table 4: In high molecular weight organic material the pigments yield colourations having the shade od colour indicated in each case and having very good fastness to weathering.

TABLE 4

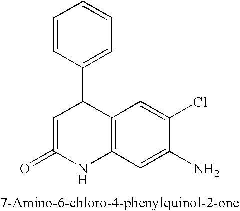

| Example | Coupling component | Shade |
|---|---|---|
| 142 | 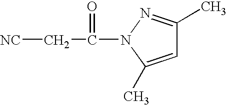 | violet |
| 143 | 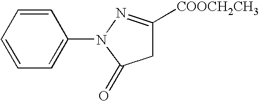 | |
| 144 | 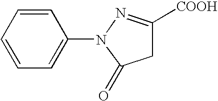 | |
| 145 | 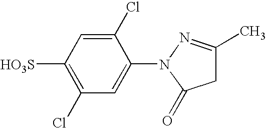 | |
| 146 | 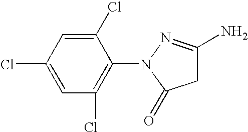 | |
| 147 | 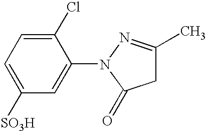 | |
| 148 | 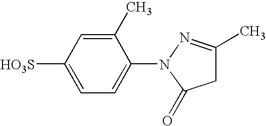 | |
| 149 | 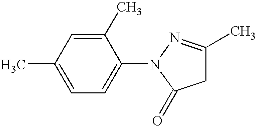 | |
| 150 | 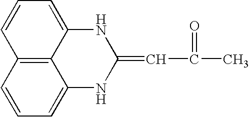 | |
| 151 | 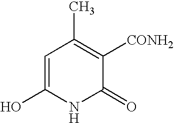 | |
| 152 | 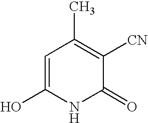 | reddish-yellow |
| 153 | 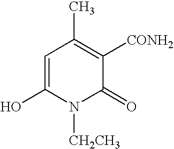 | reddish-yellow |
| 154 | 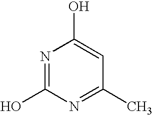 | |
| 155 | 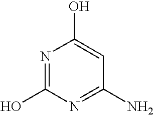 | |
| 156 | 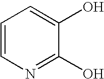 | |
| 157 | 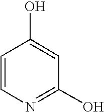 | |
| 158 | 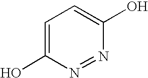 | |
| 159 | 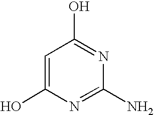 | |
| 160 | 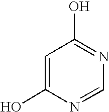 | |
| 161 | 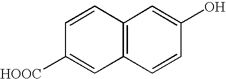 | red |
| 162 | 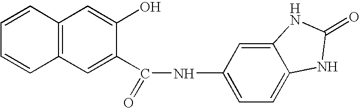 | claret |
| 163 | 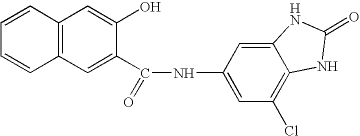 | claret |
| 164 | 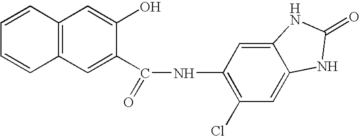 | claret |
| 165 | 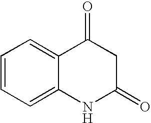 | reddish-yellow |

### EXAMPLE 166

15.0 ml of pyridine are added to a solution of 173.0 g (0.9 mol) of ethylbenzoyl acetate in 3.2 litres of xylene, and the mixture is heated to 130-135° C. At that temperature, 107.0 g (0.75 mol) of 4-chloro-1,3-phenylenediamine are added in portions to the solution and the ethynol that is liberated is distilled off continuously. After 5 hours, the reddish-brown solution is cooled to 25° C. and 14.3 g (75 mol) of p-toluenesulfonic acid are added thereto. The resulting green suspension is then boiled for 6 hours under reflux, the water of reaction being distilled off. The suspension, which is now yellow, is allowed to cool to room temperature. Filtration is then carried out, the precipitate is washed with a total of 500 ml of ethanol in three portions, and the crude product is dried for 20 hours at 80° C. under a laboratory vacuum. There are obtained 179 g (0.66 mol, yield 88% of theory) of a beige-brown powder of formula 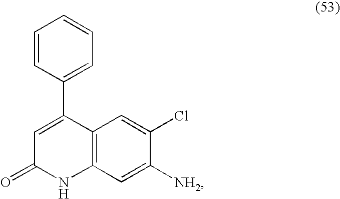
which, after recrystallisation from acetic acid, is in the form of white crystals having a melting point of 327° C.

### EXAMPLE 167

Analogously to the procedure described in Example 166 it is possible to obtain the compound of formula 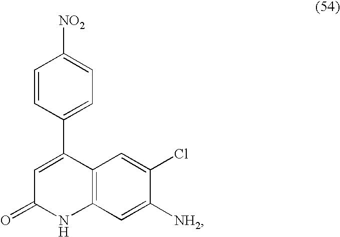
which, after recrystallisation from acetic acid, is in the form of yellow crystals having a melting point of 370° C. with decomposition.

### APPLICATION EXAMPLE 1

Use in the colouring of plastics in the mass

0.6 g of the pigment of formula (3) is mixed with 67 g of polyvinyl chloride, 33 g of dioctyl phthalate, 2 g of dibutyltin dilaurate and 2 g of titanium dioxide and processed into a thin film on a roller apparatus for 15 minutes at 160° C. The yellow PVC film so produced is tinctorially strong and fast to light.

### APPLICATION EXAMPLE 2

Use in an alkyd-melamine stoving lacquer

A mixture of 460 g of steatite spheres having a diameter of 8 mm, an alkyd lacquer consisting of 58.7 g of alkyd resin ®Alkydal F 310 (Bayer AG), 60% in xylene, 58.7 g of alkyd resin ®Alkydal F 32 (Bayer AG), 60% in xylene, 2.0 g of ®Silikonöl A (Bayer AG), 1% in xylene, 4.0 g of n-butanol, 4.0 g of Dowanol, 15 g of xylene, 5.6 g of dispersing agent ®Disperbyk D-160 (BYK-Chemie) and also 28.0 g of the pigment of formula (3) is dispersed in a glass bottle having a twist-off cap for 72 hours on a roller rack. After addition of 24.0 g of the melamine component ®Cymel 327 (Cyanamid), 90% in xylene, dispersion is continued for a further one hour on the roller rack. The steatite spheres are then separated off. The resulting coloured lacquer paste is applied to ®Milar transparent films and then stoved for 30 minutes at 130° C. (lacquer layer thickness 50 μm). A colouration having excellent coloristic and Theological properties is obtained.

### APPLICATION EXAMPLE 3

Preparation of an intaglio/flexographic printing ink
15 g of the pigment of formula (3),
20 g of clear lacquer consisting of
   20 g of nitrocellulose type A
   4 g of dioctyl phthalate
   56 g of ethanol and
   20 g of ethyl acetate and
25 g of ethanol
   are dispersed for 30 minutes by means of a high-speed stirrer (dissolver at 15 m/s). 40 g of the clear lacquer described above are then added to the batch, and dispersion is carried out for a further 5 minutes with the dissolver. The grinding charge is introduced into a bead mill by means of a pump with coarse filtering, and is finely dispersed therein. Extraordinary transparency/gloss properties are obtained with that printing ink both in intaglio/flexographic printing and in offset printing.

### APPLICATION EXAMPLE 4

Production of a colour filter for liquid crystal displays (LCD)

In a 100 ml glass vessel containing 83.3 g of zirconium ceramic spheres, 2.8 g of the pigment of formula (3), 0.28 g of Solsperse® 5000, 4.10 g of Disperbyko® 161 (dispersing agent, 30% solution of a high molecular weight block copolymer containing groups having affinity for pigments, in n-butyl acetate/1-methoxy-2-propyl acetate 1:6, BYK Chemie) and 14.62 g of propylene glycol monomethyl ether acetate (MPA, CAS Reg. No. 108-65-6) are stirred by means of a Dispermat for 10 minutes at 1000 rev./min. and for 180 minutes at 3000 rev./min. at 23° C. After addition of 4.01 g of an acrylate polymer binder (35% solution in MPA), stirring is carried out for 30 minutes at 3000 rev./min. at room temperature. After separating off the spheres, the dispersion is diluted with the same weight of MPA.

A glass substrate (Corning type 1737-F) is coated with that dispersion on a centrifugal lacquer coating apparatus and spun off for 30 seconds at 1000 rev./min. Drying of the layer is carried out for 2 minutes at 100° C. and for 5 minutes at 200° C. on a hotplate. The layer thickness achieved is 0.4 μm.

### APPLICATION EXAMPLE 5

A mixture of 1.0 g of the pigment of formula (3), 1.0 g of a commercially available antioxidant (®Irganox1010, Ciba Specialty Chemicals AG) and 1000 g of polyethylene HD granules (®Vestolen 60-16, Huels) is pre-mixed for 15 minutes in a glass bottle on a roller bench. The mixture is then extruded on a single-screw extruder in two passes, and the granules so obtained are compressed into sheets on an injection-moulding machine (Ferromatik Aarburg 200) for 5 minutes at 200° C., 5 minutes at 240° C., 5 minutes at 260° C., 5 minutes at 280° C. and 5 minutes at 300° C.

The sheets exhibit tinctorially strong yellow shades with good resistance properties.

1. A monoazoquinolone pigment which, in one of its tautomeric forms, corresponds to formula 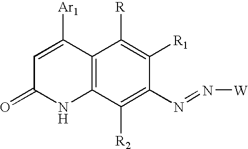
wherein
W is unsubstituted or substituted C₆-C₂₄aryl or unsubstituted or substituted heteroaryl or is a radical derived from a compound of formula 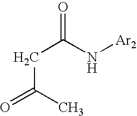
wherein
Ar₂ is unsubstituted or substituted C₆-C₂₄aryl or unsubstituted or substituted heteroaryl,
Ar₁ is unsubstituted or substituted C₆-C₂₄aryl or unsubstituted or substituted heteroaryl,
R, R₁ and R₂ are each independently of the others hydrogen, C₁-C₆alkyl, halogen, cyano, CF₃, nitro,
NR₃R₄, COOR₄, NR₄COR₃, COO⁻X⁺, COR₄, OR₄, SR₃, SO₂R₃, SO₂NR₃R₄, SO₃⁻X⁺, or C₆-C₂₄aryl which is unsubstituted or mono- or poly-substituted by R₅,
R₃ is C₁-C₆alkyl, or C₆-Cl₂aryl which is unsubstituted or mono- or poly-substituted by halogen, hydroxy, OR₇, cyano, nitro, SR₇, NR₆R₇, COOR₇, CONR₆R₇, NR₆COR₇, NR₆COOR₇, COO⁻X⁺, COR₄,
OR₄, SO₂R₇, SO₂NR₆R₇, SO₃^{-X}⁺ or by SO₃R₇,
R₄ is hydrogen or has the meanings of R₃,
R₅ is hydrogen, C₁-C₄alkyl, halogen, nitro, NR₇R₈ or OR₇,
R₆ is hydrogen or C₁-C₃alkyl,
R₇ and R₈ are each independently of the other hydrogen; C₁-C₃alkyl; phenyl which is unsubstituted or mono- or poly-substituted by halogen, nitro, OR₅, NR₁₆R₁₇; or benzyl which is unsubstituted or mono- or poly-substituted by halogen, nitro, OR₅, NR₁₆R₁₇, and
X⁺ is a cation H⁺, Li⁺, Na⁺, K⁺, Mg⁺⁺_{1/2}, Ca⁺⁺_{1/2}, Sr⁺⁺_{1/2}, Ba⁺⁺_{1/2}, Cu⁺, Cu⁺⁺_{1/2}, Zn⁺⁺_{1/2}, Mn⁺⁺_{1/2}, Al⁺⁺⁺_{1/2} or [NR₉R₁₀R₁₁R₁₂]⁺, wherein R₉, R₁₀, R₁₁ and R₁₂ are each independently of the others hydrogen; C₁-C₆alkyl; phenyl which is unsubstituted or mono- or poly-substituted by C₁-C₆alkyl, halogen, nitro, OR₅, NR₁₆R₁₇; or benzyl which is unsubstituted or mono- or poly-substituted by C₁-C₆alkyl, halogen, nitro, OR₅, NR₁₆R₁₇, and
R₁₆ and R₁₇ are each independently of the other hydrogen or C₁-C₆alkyl.

2. A monoazoquinolone pigment according to claim 1, of formula 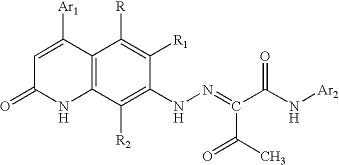
wherein
Ar₁ and Ar₂ are each independently of the other unsubstituted or substituted C₆-C₂₄aryl or unsubstituted or substituted heteroaryl,
R, R₁ and R₂ are each independently of the others hydrogen, C₁-C₆alkyl, halogen, cyano, CF₃, nitro, NR₃R₄, COOR₄, NR₄COR₃, COO⁻X⁺, COR₄, OR₄, SR₃, SO₂R₃, SO₂NR₃R₄, SO₃⁻X⁺, or C₆-C₂₄aryl which is unsubstituted or mono- or poly-substituted by R₅,
R₃ is C₁-C₆alkyl, or C₆-C₁₂aryl which is unsubstituted or mono- or poly-substituted by halogen, hydroxy, OR₇, cyano, nitro, SR₇, NR₆R₇, COOR₇, CONR₆R₇, NR₆COR₇, NR₆COOR₇, COO⁻X⁺, COR₄, OR₄, SO₂R₇, SO₂NR₆R₇, SO₃⁻X⁺ or by SO₃R₇,
R₄ is hydrogen or has the meanings of R₃,
R₅ is hydrogen, C₁-C₄alkyl, halogen, nitro, NR₇R₈ or OR₇,
R₆ is hydrogen or C₁-C₃alkyl,
R₇ and R₈ are each independently of the other hydrogen; C₁-C₃alkyl; phenyl which is unsubstituted or mono- or poly-substituted by halogen, nitro, OR₅,NR₁₆R₁₇; or benzyl which is unsubstituted or mono- or poly-substituted by halogen, nitro, OR₅, NR₁₆R₁₇, and
X⁺ is a cation H⁺, Li⁺, Na⁺, K⁺, Mg⁺⁺_{1/2}, Ca⁺⁺_{1/2}, Sr⁺⁺_{1/2}, Ba⁺⁺_{1/2}, Cu⁺, Cu⁺⁺_{1/2}, Zn⁺⁺_{1/2}, Mn⁺⁺_{1/2}, Al⁺⁺⁺_{1/3} or [NR₉R₁₀R₁₁R₁₂]⁺, wherein R₉, R₁₀, R₁₁, and R₁₂ are each independently of the others hydrogen; C₁-C₆alkyl; phenyl which is unsubstituted or mono- or poly-substituted by C₁-C₆alkyl, halogen, nitro, OR₅, NR₁₆R₁₇; or benzyl which is unsubstituted or mono- or poly-substituted by C₁-C₆alkyl, halogen, nitro, OR₅, NR₁₆R₁₇, and
R₁₆ and R₁₇ are each independently of the other hydrogen or C₁-C₆alkyl.

3. A monoazoquinolone pigment according to claim 1, wherein Ar₁ is a radical of formula 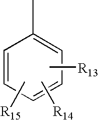
wherein
R₁₃, R₁₄ and R₁₅ are each independently of the others hydrogen, C₁-C₆alkyl, halogen, cyano, CF₃, nitro, NR₃R₄, COOR₄, NR₄COR₃, COO⁻X⁺, COR₄, OR₄, SR₃, SO₂R₃, SO₂NR₃R₄, SO₃R₄, SO₃⁻X⁺, or C₆-C₁₂aryl which is unsubstituted or mono- or poly-substituted by R₅.

4. A monoazoquinolone pigment according to claim 2, wherein Ar₂ is a radical of formula 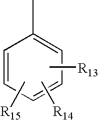
wherein
R₁₃, R₁₄ and R₁₅ are each independently of the others hydrogen, C₁-C₆alkyl, halogen, cyano, CF₃, nitro, NR₃R₄, COOR₄, NR₄COR₃, COO⁻X⁺, COR₄, OR₄, SR₃, SO₂R₃, SO₂R₃, SO₂NR₃R₄, SO₃R₄, SO₃⁻X⁺, or C₆-C₁₂aryl which is unsubstituted or mono- or poly-substituted by R₅.

5. A monoazoquinolone pigment according to claim 1, wherein R₁ and R₂ are each independently of the other hydrogen, C₁-C₃alkyl, C₁-C₃alkoxy, chlorine, COOR₅, NR₄COR₃, COO⁻X⁺ or SO₃³¹ X⁺, R₅ is hydrogen or C₁-C₃alkyl and X⁺ is a cation Na⁺, Mg⁺⁺_{1/2}, Ca⁺⁺_{1/2}, Sr⁺⁺_{1/2}, Ba⁺⁺_{1/2} or [NR₉R₁₀R₁₁R₁₂]⁺, wherein R₉, R₁₀, R₁₁ and R₁₂ are each independently of the others hydrogen; C₁-C₆alkyl; phenyl which is unsubstituted or mono- or poly-substituted by C₁-C₃alkyl, halogen, nitro, OR₇, N(R₇)₂; or benzyl which is unsubstituted or mono- or poly-substituted by C₁-C₃alkyl, halogen, nitro, OR₇, N(R₇)₂.

6. A monoazoquinolone pigment according to claim 1, wherein R₁ and R₂ are each independently of the other hydrogen, C₁-C₂alkyl, C₁-C₂alkoxy, chlorine, COOR₅, NR₄COR₃, COO⁻X⁺ or SO₃⁻X⁺, R₅ is hydrogen or C₁-C₂alkyl and X⁺ is a cation Na⁺⁺_{1/2}, Ca⁺⁺_{1/2}, Sr⁺⁺_{1/2}, Ba⁺⁺_{1/2} or [NR₉R₁₀R₁₁R₁₂]⁺, wherein R₉, R₁₀, R₁₁ and R₁₂ are each independently of the others hydrogen, C₁-C₆alkyl, phenyl which is unsubstituted or mono- or poly-substituted by C₁-C₂alkyl and/or by halogen, or benzyl which is unsubstituted or mono- or poly-substituted by C₁-C₂alkyl and/or by halogen.

7. A monoazoquinolone pigment according to claim 6, wherein R₁ and R₂ are each independently of the other hydrogen, C₁-C₂alkyl, C₁-C₂alkoxy, chlorine, COOR₅ or NR₄COR₃ and R₅ is hydrogen or C₁-C₂alkyl.

8. A process for the preparation of a monoazoquinolone pigment of formula (1) according to claim 1, wherein a compound of formula 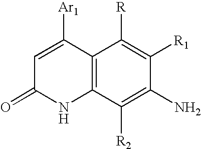
is diazotised and coupled to a compound of formula
W—H
or to a compound of formula 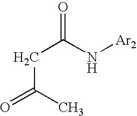
wherein Ar₁, W, R, R₂ and R₂ are as defined for formula (1) in claim 1 and Ar₂ is as defined for formula (1a) in claim 1.

9. A composition comprising a monoazoquinolone pigment according to claim 1 and a high molecular weight material.

10. A plastic, surface coating or printing ink composition comprising a monoazoquinolone pigment according to claim 1.

11. A composition accordinq to claim 9 which is a color filter.

12. A monoazoquinolone pigment according to claim 2, wherein Ar₁ is a radical of formula 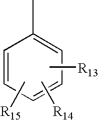
wherein
R₁₃, R₁₄ and R₁₅ are each independently of the others hydrogen, C₁-C₆alkyl, halogen, cyano, CF₃, nitro, NR₃R₄, COOR₄, NR₄COR₃, COO⁻, X⁺, COR₄, OR₄, SR₃, SO₂R₃, SO₂NR₃R₄, SO₃R₄, SO₃⁻X⁺, or C₆-C₁₂aryl which is unsubstituted or mono- or poly-substituted by R₅.

13. A monoazoquinolone pigment according to claim 3, wherein Ar₂ is a radical of formula 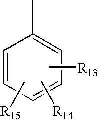
wherein
R₁₃, R₁₄ and R₁₅ are each independently of the others hydrogen, C₁-C₆alkyl, halogen, cyano, CF₃, nitro, NR₃R₄, COOR₄, NR₄COR₃, COO⁻X⁺, COR₄, OR₄, SR₃, SO₂R₃, SO₂NR₃R₄, SO₃R₄, SO₃⁻X⁺, or C₆-C₁₂aryl which is unsubstituted or mono- or poly-substituted by R₅.

14. A monoazoquinolone pigment according to claim 2, wherein R₁ and R₂ are each independently of the other hydrogen, C₁-C₃alkyl, C₁-C₃alkoxy, chlorine, COOR₅, NR₄COR₃, COO⁻X⁺ or SO₃⁻X⁺, R₅ is hydrogen or C₁-C₃alkyl and X⁺ is a cation Na⁺, Mg⁺⁺_{1/2}, Ca⁺⁺_{1/2}, Sr⁺⁺_{1/2}, Ba⁺⁺_{1/2} or [NR₉R₁₀R₁₁R₁₂]⁺, wherein R₉, R₁₀, R₁₁, and R₁₂ are each independently of the others hydrogen; C₁-C₆alkyl; phenyl which is unsubstituted or mono- or poly-substituted by C₁-C₃alkyl, halogen, nitro, OR₇, N(R₇)₂; or benzyl which is unsubstituted or mono- or poly-substituted by C₁-C₃alkyl, halogen, nitro, OR₇, N(R₇)₂.

15. A monoazoquinolone pigment according to claim 2, wherein R₁ and R₂ are each independently of the other hydrogen, C₁-C₂alkyl, C₁-C₂alkoxy, chlorine, COOR₅, NR₄COR₃, COO⁻X⁺ or SO₃⁻X⁺, R₅ is hydrogen or C₁-C₂alkyl and X⁺ is a cation Na⁺, Mg⁺⁺_{1/2}, Ca⁺⁺_{1/2}, Sr⁺⁺_{1/2}, Ba⁺⁺_{1/2} or [NR₉R₁₀R_{11R}₁₂]⁺, wherein R₉, R₁₀, R₁₁ and R₁₂ are each independently of the others hydrogen, C₁-C₆alkyl, phenyl which is unsubstituted or mono- or poly-substituted by C₁-C₂alkyl and/or by halogen, or benzyl which is unsubstituted or mono- or poly-substituted by C₁-C₂alkyl and/or by halogen.

16. A monoazoquinolone pigment according to claim 15, wherein R₁ and R₂ are each independently of the other hydrogen, C₁-C₂alkyl, C₁-C₂alkoxy, chlorine, COOR₅ or NR₄COR₃ and R₅ is hydrogen or C₁-C₂alkyl.

17. A monoazoquinolone pigment according to claim 3, wherein R₁ and R₂ are each independently of the other hydrogen, C₁-C₃alkyl, C₁-C₃alkoxy, chlorine, COOR₅, NR₄COR₃, COO⁻X⁺ or SO₃⁻X⁺, R₅ is hydrogen or C₁-C₃alkyl and X⁺ is a cation Na⁺, Mg⁺⁺_{1/2}, Ca⁺⁺_{1/2}, Sr⁺⁺_{1/2}, Ba⁺⁺_{1/2} or [NR₉R₁₀R₁₁,R₁₂]⁺, wherein R₉, R₁₀, R₁₁ and R₁₂ are each independently of the others hydrogen; C₁-C₆alkyl; phenyl which is unsubstituted or mono- or poly-substituted by C₁-C₃alkyl, halogen, nitro, OR₇, N(R₇)₂; or benzyl which is unsubstituted or mono- or poly-substituted by C₁-C₃alkyl, halogen, nitro, OR₇, N(R₇)₂.

18. A monoazoquinolone pigment according to claim 3, wherein R₁ and R₂ are each independently of the other hydrogen, C₁-C₂alkyl, C₁-C₂alkoxy, chlorine, COOR₅, NR₄COR₃, COO⁻X⁺ or SO₃⁻X⁺, R₅ is hydrogen or C₁-C₂alkyl and X⁺ is a cation Na⁺, Mg⁺⁺_{1/2}, Ca⁺⁺_{1/2}, Sr⁺⁺_{1/2}, Ba⁺⁺_{1/2} or [NR₉R₁₀R₁₁R₁₂]⁺, wherein R₉, R₁₀, R₁₁ and R₁₂ are each independently of the others hydrogen, C₁-C₆alkyl, phenyl which is unsubstituted or mono- or poly-substituted by C₁-C₂alkyl and/or by halogen, or benzyl which is unsubstituted or mono- or poly-substituted by C₁-C₂alkyl and/or by halogen.

19. A monoazoquinolone pigment according to claim 4, wherein R₁ and R₂ are each independently of the other hydrogen, C₁-C₃alkyl, C₁-C₃alkoxy, chlorine, COOR₅, NR₄COR₃, COO⁻X⁺ or SO₃⁻X⁺, R₅ is hydrogen or C₁-C₃alkyl and X⁺ is a cation Na⁺, Mg⁺⁺_{1/2}, Ca⁺⁺_{1/2}, Sr⁺⁺_{1/2}, Ba⁺⁺_{1/2} or [NR₉R₁₀R₁₁R₁₂]⁺, wherein R₉, R₁₀, R₁₁ and R₁₂ are each independently of the others hydrogen; C₁-C₆alkyl; phenyl which is unsubstituted or mono- or poly-substituted by C₁-C₃alkyl, halogen, nitro, OR₇, N(R₇)₂; or benzyl which is unsubstituted or mono- or poly-substituted by C₁-C₃alkyl, halogen, nitro, OR₇, N(R₇)₂.

20. A monoazoquinolone pigment according to claim 4, wherein R₁ and R₂ are each independently of the other hydrogen, C₁-C₂alkyl, C₁-C₂alkoxy, chlorine, COOR₅, NR₄COR₃, COO⁻X⁺ or SO₃⁻X⁺, R₅ is hydrogen or C₁-C₂alkyl and X⁺ is a cation Na⁺, Mg⁺⁺_{1/2}, Ca⁺⁺_{1/2}, Sr+Sr⁺⁺_{1/2}, Ba⁺⁺_{1/2} or [NR₉R₁₀R₁₁R₁₂]⁺, wherein R₉, R₁₀, R₁₁ and R₁₂ are each independently of the others hydrogen, C₁-C₆alkyl, phenyl which is unsubstituted or mono- or poly-substituted by C₁-C₂alkyl and/or by halogen, or benzyl which is unsubstituted or mono- or poly-substituted by C₁-C₂alkyl and/or by halogen.
